(19) United States
(12) Patent Application Publication
(10) Pub. No.: US 2012/0330446 A1
(43) Pub. Date: Dec. 27, 2012

(54) MICRO-PROCESSING DEVICE CONTROL SYSTEM AND METHOD OF USE THEREOF

(75) Inventor: Yiu Ming Kenneth HO, New Territories (HK)

(73) Assignee: Centek International (HK) Ltd

(21) Appl. No.: 13/533,072

(22) Filed: Jun. 26, 2012

(30) Foreign Application Priority Data
Jun. 27, 2011 (GB) 1110839.6

(51) Int. Cl. G06F 17/00

(52) U.S. Cl. 700/94

(57) ABSTRACT

A micro-processing device control system is provided. The system includes a micro-processing device, and a further electronic device connectable to or capable of communication with said micro-processing device to allow said micro-processing device to control one or more functions of said further electronic device. The micro-processing device includes audio connection means and microphone connection means. The audio connection means are arranged so as to be able to transmit one or more audio data signals and control data signals to said further electronic device. The microphone connection means are arranged so as to be able to receive one or more audio data signals and control data signals from said further electronic device for allowing control and/or feedback from said further electronic device to said micro-processing device.

This invention relates to a micro-processing device control system and a method of use thereof.

Although the following description refers almost exclusively to a hand held micro-processing device in the form of a smart phone for controlling one or more functions of a toy, it will be appreciated by persons skilled in the art that the micro-processing device could be any electronic device having suitable audio means for controlling one or more functions of any further electronic device.

It is known to use a smart phone for the purposes of controlling a toy, such as for example a robot. The communication between the phone and the toy can take place wirelessly via radio waves, infra-red and/or the like. It is also known to use an audio channel or jack to send data signals from the phone to the toy for controlling the toy.

It is an aim of the present invention to provide a micro-processing device control system that provides enhanced control of a further electronic device.

It is a further aim of the present invention to provide a method of using a micro-processing device control system.

It is a yet further aim of the present invention to provide toy apparatus including an enhanced micro-processing device control system.

It is a yet further aim of the present invention to provide a method of using toy apparatus including a micro-processing device control system.

According to a first aspect of the present invention there is provided a micro-processing device control system, said system including a micro-processing device, and a further electronic device connectable to or capable of communication with said micro-processing device to allow said micro-processing device to control one or more functions of said further electronic device, said micro-processing device including audio connection means and microphone connection means, said audio connection means arranged so as to be able to transmit one or more audio data signals and control data signals to said further electronic device, and wherein said microphone connection means are arranged so as to be able to receive one or more audio data signals and control data signals from said further electronic device for allowing control and/or feedback from said further electronic device to said micro-processing device.

Thus, the system of the present invention allows two-way communication between the further electronic device and the micro-processing device using audio and microphone connection means associated with the micro-processing device to provide both a control and feedback system. The microphone connection means of the micro-processing device in particular is able to receive two types of data signals from the further electronic device; audio data signals and control data signals, thereby allowing the microphone connection means to function in a conventional manner for receiving audio data but also to function in a non-conventional manner for receiving control data signals to provide feedback to the micro-processing device from the further electronic device. This is in contrast to the prior art which is limited to the provision of audio data and control data in a single direction from the micro-processing device to a further electronic device using the audio connection means. By providing the control and feedback system of the present invention, this allows the powerful hardware provided in the micro-processing device to be used to control the further electronic device connected to or in communication with the micro-processing device, thereby allowing the further electronic device to be provided at low cost and be both quick and easy to manufacture.

Preferably the micro-processing device and/or further electronic device is/are hand held devices or are of such dimensions to be capable of being held in a user's hand.

Preferably the control data signals are one or more electronic, digital and/or radio frequency signals that allow control of one or more functions of the device to which they are received by. Preferably the audio data signals are one or more electronic, digital and/or radio frequency signals that contain or convey audio data therein.

Preferably the audio connection means includes at least one audio output connection port or channel. If only one audio output connection port or channel is provided, time division methodology can be used to allow both audio data signals and control data signals to be transmitted from the micro-processing device to the further electronic device.

Preferably the audio connection port also provides the at least one microphone connection means. For example, a microphone input connection means can be integral with the audio connection port.

Preferably the audio connection means includes at least two audio output means or channels to provide a stereo audio output, such as for example a left audio output and a right audio output. One of the audio output means or channels is typically used to send one or more data or control commands/signals to the further electronic device. The at least other audio output means, channel or connector is typically used to send one or more audio data signals to the further electronic device, such as for example by sending voice input or sound wave audio to a speaker of the further electronic device.

Preferably the microphone connection means includes at least one microphone input or channel. The microphone input or channel is typically used to receive one or more control data signals, audio sound signals and/or voice input signals sent from the further electronic device to the micro-processing device.

Preferably if a single microphone input or channel is provided, said input or channel receives the two different types of data signals (i.e. the control data signals and the audio data signals) using time division methodology or means. This is based on the data signals being divided into different time slots and being sent over the same channel frequency. Thus, different time slots in the microphone input or channel can be used to allow one or more control data signals to be sent from the further electronic device to the micro-processing device, together with the one or more audio sound and/or voice input data signals.

In one embodiment the micro-processing device includes a jack including at least three channels; two audio channels and one microphone channel. Preferably one audio channel is used to output one or more audio data signals, one audio channel is used to output one or more control signals, and the microphone channel is used to receive one or more audio and control data signals.

In one embodiment the micro-processing device includes four channels; two audio channels and two microphone channels. In this embodiment control data signals are sent from the micro-processing device to the further electronic device on a first audio output channel, audio data signals are sent from the micro-processing device to the further electronic device on a second audio output channel, control data signals are sent from the further electronic device to the micro-processing device on a first microphone input channel and audio data signals are sent from the further electronic device to the micro-processing device on a second microphone input channel.

Preferably the further electronic device is connected to the micro-processing device via any or any combination of one or more wires, cables, audio cables, headphone cables and/or the like. For example the further electronic device can be connected to the hand held device via a head phone cable.

In one embodiment the further electronic device can communicate via wireless communication means, such as via radio frequency means and/or the like.

The micro-processing device typically includes software, such as for example a downloadable software application or “app”, to allow communication with and/or control of the further electronic device.

The micro-processing device can include any or any device including micro-processing means or micro-controller means (MCU) therein, such as a smart phone, mobile phone, personal digital assistant (PDA), palm computer, MP3 player, Android phone, I-Phone, and/or the like.

In a preferred embodiment the micro-processing means also includes any or any combination of Internet connection means or WiFi; gyro-sensing means or a gyro-sensor; acceleration measuring means or an accelerometer; wireless communication means, such as Bluetooth; navigation means, such as a Global Positioning System (GPS); camera means; video means, mobile telephone communication means and/or the like.

The further electronic device can include any device including micro-processing means or microcontroller means (MCU) therein. For example, the electronic device could be in the form of an electronic toy.

The micro-processing device and further electronic device can be referred to as first and second electronic and/or micro-processing devices respectively if required.

Preferably the further electronic device includes one or more input/output (IO) means or pins for allowing the micro-processing means or MCU of the further electronic device to control one or more peripheral devices, such as for example one or more electrical or electronic peripheral devices. For example, the one or more IO means or pins could control the output or input of one or more peripheral devices, such as for example, any or any combination of drive means for driving movement of one or more objects in use, illumination means for illuminating one or more objects in use, sensing means for sensing one or more objects in use, actuation means for allowing actuation of one or more objects in use, speaker means for sounding audio data and/or the like.

In one embodiment the further electronic device is in the form of a toy. Preferably one or more peripheral devices are provided in, form part of or are associated with the toy and said further electronic device controls the one or more peripheral devices.

In one embodiment the one or more IO means or pins allow output control of peripheral devices in the form of one or more motors, light emitting diodes (LEDs) and/or the like. In one embodiment the one or more IO means or pins allows input control of one or more peripheral devices, such as a microphone, one or more touch sensors or push buttons, buttons and/or the like. The microphone can be used to allow the further electronic device to receive external voice and/or audio data signals and send the same back to the hand held device via the microphone channel of the micro-processing device.

In one embodiment the control system includes a single micro-processing device and at least one further electronic device, the micro-processing device and at least one further electronic device are typically separate independent devices. Preferably one or both of the devices are hand held devices. For example, the hand held devices can be in the form of a smart phone and the further electronic device can be in the form of a toy. The hardware of the smart phone is used to control one or more functions of the toy.

In a further embodiment the control system includes two or more micro-processing devices and at least one further electronic device. Preferably the two micro-processing devices are hand held devices. In this embodiment, preferably at least one of the micro-processing devices is associated with, provided in or forms part of the at least one further electronic device. For example, two or more hand held micro-processing devices could be in the form of smart phones and the further electronic device could be in the form of a toy. One of the smart phones could form part of the toy (smart phone/toy combination) and the other smart phone could be used as a wireless remote control device for the smart phone/toy combination.

Preferably the two or more micro-processing devices include wired or wireless communication means to allow communication between the micro-processing devices.

Preferably the wireless communication means include radio frequency means.

Preferably the at least one further electronic device has location means associated with the same to allow location of the first or one of the micro-processing device therewith in use. The location means can include any or any combination of one or more recesses, apertures, cavities, clips, attachment means and/or the like.

In one embodiment the further electronic device is in the form of a toy, robot, doll and/or the like.

According to a second aspect of the present invention there is provided toy apparatus including a micro-processing device control system. The control system can include at least one micro-processing device and at least one further electronic device.

Preferably the toy apparatus includes at least one toy component and the at least one further electronic device is the toy component or is associated with, provided on or forms part of the toy component.

According to a third aspect of the present invention is provided a method of using a micro-processing device control system, said system including a micro-processing device, and a further electronic device connectable to or capable of communication with said micro-processing device, said micro-processing device including audio connection means and microphone connection means, and wherein said method includes the steps of using said audio connection means to transmit one or more audio data signals and control data signals to said further electronic device to allow said micro-processing device to control one or more functions of said further electronic device, and using said microphone connection means to receive one or more audio data signals and control data signals from said further electronic device for allowing control and/or feedback from said further electronic device to said micro-processing device.

According to a further aspect of the present invention there is provided a method of using toy apparatus including a micro-processing device control system.

Although the description refers to the audio connection means and the microphone connection means arranged to receive both audio and control data signals. It will be appreciated that this means that each of the audio connection means and the microphone connection means is capable of receiving/sending both types of signals, not that both types of signals are necessarily received/sent at the same time via said connection means.

Embodiments of the present invention will now be described with reference to the accompanying figures, wherein:

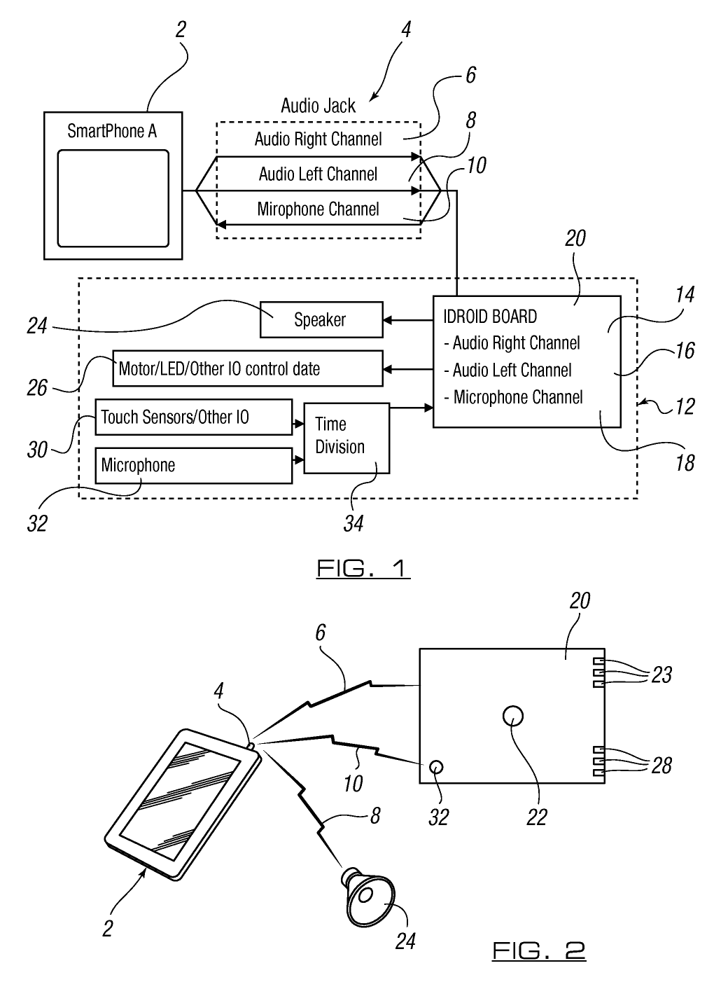

FIG. 1 is a simplified block diagram showing the main connections between a smart phone and a further electronic device according to a first embodiment of the present invention;

FIG. 2 is a schematic drawing of the components shown in FIG. 1;

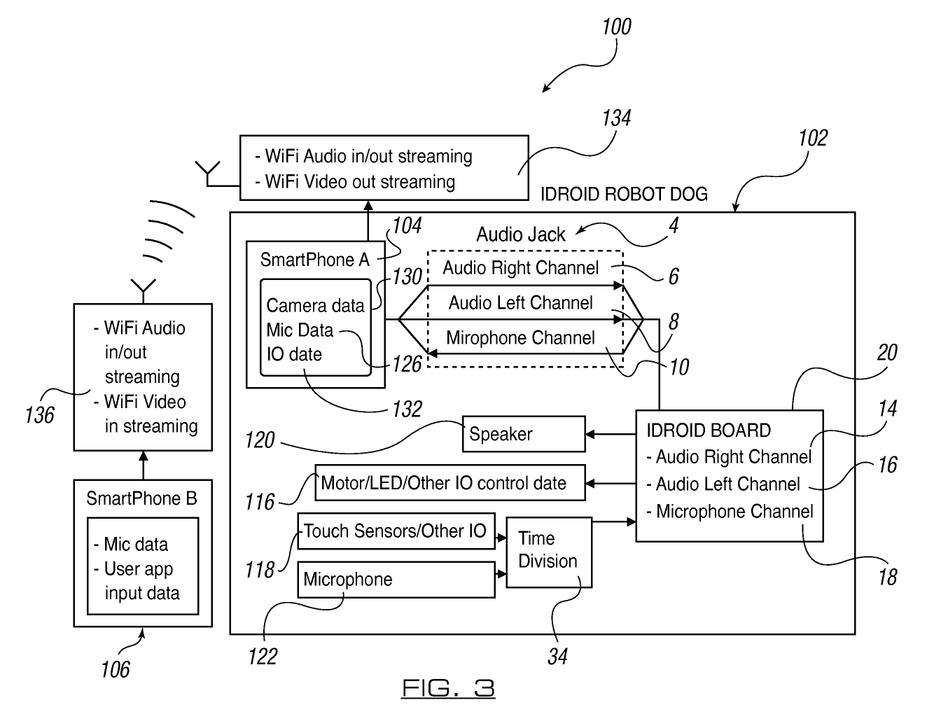

FIG. 3 is a simplified block diagram showing the main connections between a first and a second smart phone and an electronic device in the form of a robot according to a second embodiment of the present invention;

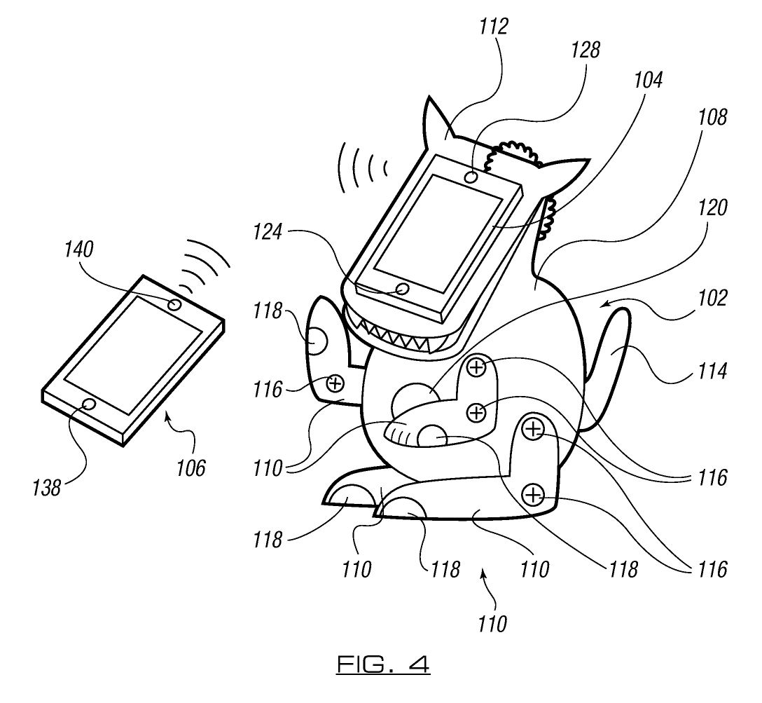

FIG. 4 is a schematic drawing of the components shown in FIG. 3; and

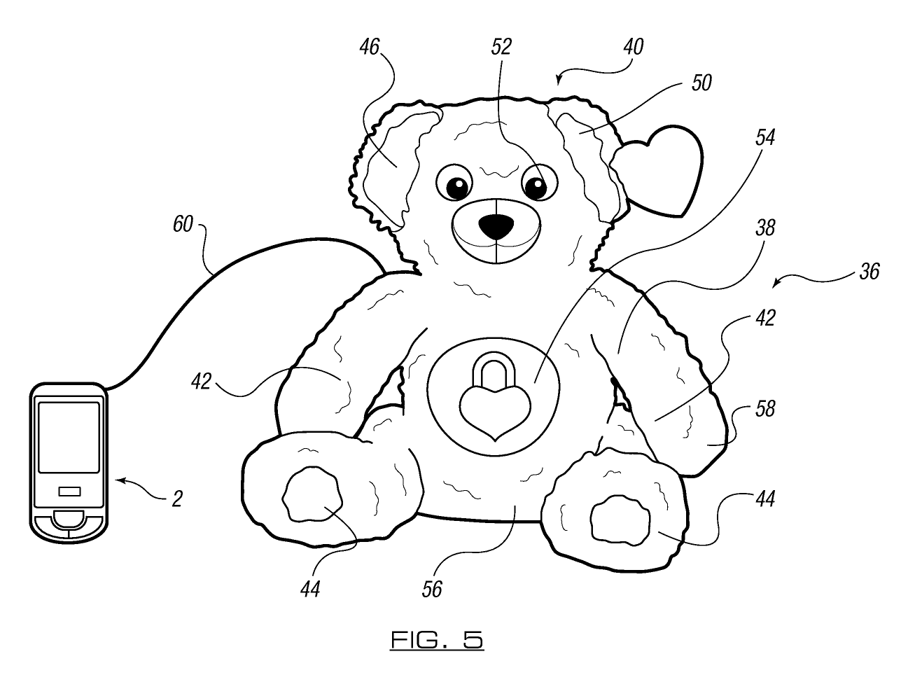

FIG. 5 illustrates a specific example of the embodiment shown in FIGS. 1-2.

Referring to FIGS. 1 and 2, there is illustrated a control system according to an embodiment of the present invention for allowing one or more functions of an electronic device 12 to be controlled using the hardware and software of a hand held micro-processing device in the form of a smart phone 2.

The smart phone 2 has audio and microphone connection means in the form of an audio jack 4 including three channels; a right audio output channel 6, a left audio output channel 8 and a microphone input channel 10. One of the left or right audio channels 6, 8 is used to send one or more data command signals to the device 12 for controlling one or more functions of said device. The other of the left or right audio channels 6, 8 is used to send one or more audio and/or voice data signals to the device 12. The microphone input channel 10 is used to receive one or more audio and/or voice data signals from the device 12, together with one or more control data signals from the device 12. Time division methodology is used to allow both the control data signals and the audio/voice data signals to be transmitted via the microphone input channel 10.

The electronic device 12 includes right audio channel input means 14, left audio channel input means 16 and a microphone output means 18. These input/output means communicate with an integrated circuit (IC) board 20 including an MCU 22. The IC board 20 includes a number of IO pins for controlling one or more peripheral devices associated with electronic device 12. For example, the IO pins 23 can be used for outputting one or more data signals from the IC for the control of a speaker 24, one or more motors or LEDs 26. IO pins 28 can be used for inputting one or more data signals from one or more touch sensors 30 or a microphone 32. The audio signals from the microphone 32 are processed by the IC 20 using time division methodology 34 for sending one or more data signals back to the smart phone 2 via microphone channel 10.

For example, the electronic device could be in the form of a teddy bear 36, as shown in FIG. 5. The teddy bear has a body portion 38, a head 40, arms 42 and legs 44. Peripheral devices are embedded in the teddy bear and include a microphone 46 provided in the ear 48 of bear 36, a motor 50 associated with the eyes 52 of bear 36, a speaker 54 provided in the body portion 38 of bear 36, a LED 56 provided in the body portion 38 of bear 36 and push button or touch sensors 58 provided in the arms 42 of bear 36.

The microphone 46 is able to record voice and/or audio data and transmit the same to the smart phone 2 connected to the bear 36 via head phone cable 60. The motor 50 is able to drive movement of the eyes of the bear following receipt of a control signal from the smart phone 2. The speaker 54 is able to play audio and/or voice data processed by the bear 36 and/or transmitted from the phone 2 to the bear 36 via an audio channel of the head phone cable 60. The LED is able to move between illuminated and non-illuminated conditions on receipt of a control signal from the smart phone 2. The touch sensors 58 are able to detect a user touching the arms 42 of the bear 36 and send this data to the phone 2.

In one example, a software application is run on the phone 2 for allowing connection between the bear 36 and the phone 2. The bear 36 can be activated from a “standby” or “out of use” condition to an “activated” or “in-use” condition by pushing a push button 58 on the bear. The data signal from the push button 58 is sent to phone 2. The phone 2 then sends a data signal back to bear 36 resulting in the bear playing an audio message, such as “Good Morning”, through speaker 54 in bear 36. The user can speak into the microphone 46 of the bear 36 and say “Good Morning” back. This audio data is recorded and sent to the phone 2 via the microphone channel. Voice recognition means in the phone 2 processes the speech and then sends control data back to the bear via an audio channel to turn on the LED 56 and to move the eyes 52 using motor 50. It will be appreciated that the game play can continue between the user, the bear and the phone in any suitable manner.

Referring to FIGS. 3 and 4, there is illustrated a control system for use with toy apparatus according to a second embodiment of the present invention. The toy apparatus is in the form of a robotic dog 102 including a first smart phone 104 forming part of the dog 102 and for allowing one or more functions of the robotic dog to be controlled using the hardware and software of the smart phone 104, and a second smart phone 106 for allowing remote control of the first smart phone 104 and/or dog 102.

The dog 102 includes a body portion 108 having legs 110 protruding outwardly from the body portion, a head 112 and a tail 114. Each leg 110 has two movable joint portions to provide movement of the whole or part of the leg. A motor 116 is associated with each movable joint to drive the movement of the leg part relative to the body portion in use. One or more touch sensors 118 are associated with each leg 110 of the dog to detect a user and/or one or more objects coming into contact with a leg of the dog in use. Location means in the form of a recess (not shown) is provided in the head 112 of the dog for the location of the first smart phone 104 in use. A speaker 120 is provided in the body portion 108 to allow audio data and sound to be played therefrom in use.

The dog 102 also includes an IC board 20 of a similar type to that described in the first embodiment. The IC 20 communicates with the smart phone 104 via a wired connection in a similar manner to the communication between the IC 20 and the smart phone 2 in the first embodiment. Thus, the first smart phone 104 has audio and microphone connection means in the form of an audio jack 4 including three channels; a right audio output channel 6, a left audio output channel 8 and a microphone input channel 10. One of the left or right audio channels 6, 8 is used to send one or more data command signals to the IC 20 of the dog 102 for controlling one or more functions of the dog, such as driving movement of the motors, illuminating an LED and/or the like. The other of the left or right audio channels 6, 8 is used to send one or more audio and/or voice data signals to the IC 20 of the dog 102, such as for sounding via a speaker on the dog. The microphone input channel 10 is used to receive one or more audio and/or voice data signals from the IC 20 of the dog, together with one or more control data signals from the IC 20 of the dog. Time division methodology is used to allow both the control data signals and the audio/voice data signals to be transmitted via the microphone input channel 10.

The IC 20 of the dog 102 includes right audio channel input means 14, left audio channel input means 16 and a microphone output means 18 as previously described. The IO pins of IC 20 control the output of data signals for controlling the motors 116 provided in the dog legs 110 and for controlling the output of audio sound from speaker 120. The IO pins of IC 20 also control the input of data signals from the touch sensors 118 provided in the legs 110 of the dog and audio signals from the microphone 122. The audio signals from the microphone 32 are processed by the IC 20 using time division methodology 34 for sending one or more data signals back to the smart phone 104 via microphone channel 10.

The first smart phone 104 also includes an external microphone 124 for recording audio data 126 for the phone, a camera 128 for capturing image data 130 for the phone, means for collecting IO data 132 and Internet connection means in the form of a WIFI connection 134 for allowing the transmission and/or receiving of audio and/or video data with the second smart phone 106.

The second smart phone 106 can have similar hardware features to those described in the first smart phone 104. In this embodiment, it communicates with the first smart phone 104 via the WIFI connection 136 to provide remote control of the first smart phone 104 and the dog 110. In particular, the phone 106 can be used to remotely control the motor functions of the robotic dog 102. It will be appreciated that any function of the dog could be controlled by the first or second smart phone.

A software application can be downloaded to and/or provided on the first and second smart phones 104, 106 to allow communication between the phones in use without requiring an external wireless router (i.e. a personal hotspot function is enabled on the second smart phone 106). This allows the user controlling the smart phone 106 to have full control over the functionality of dog 102 remotely.

The dog 102 will stream audio and/or video data to the second smart phone 106 so that the user of the phone can determine whether dog 102 is moving, the direction of movement, speed of movement and/or the like. The user of the phone 106 can issue voice commands to the first phone 104 via the external microphone 138 provided on the phone 106 and image data via camera 140. The voice commands can be streamed and output through speaker 120 provided on dog 102.

The smart phone 104 can be formed as an integral part of dog 102, can be detachably attached to dog 102 or can be attached to the dog via attachment means. When the smart phone 104 is not being used to communicate with dog 102 it can be used as a conventional phone.

The cameras provided on the first and second smart phones can be used to detect the position and/or movement of the relative phones using known image processing means.

1. A micro-processing device control system, said system comprising:
a micro-processing device, and a further electronic device connectable to or capable of communication with said micro-processing device to allow said micro-processing device to control one or more functions of said further electronic device, said micro-processing device including audio connection means and microphone connection means, said audio connection means arranged so as to be able to transmit one or more audio data signals and control data signals to said further electronic device, and wherein said microphone connection means are arranged so as to be able to receive one or more audio data signals and control data signals from said further electronic device for allowing control and/or feedback from said further electronic device to said micro-processing device.

2. A system according to claim 1 wherein the micro-processing device and/or the further electronic device are hand held devices and/or of such dimensions so as to allow a user to hold the same in their hand in use.

3. A system according to claim 1 wherein the audio connection means includes at least one audio connection port or channel and/or the microphone connection means includes at least one microphone connection port or channel.

4. A system according to claim 3 wherein if a single audio connection port or channel and/or a single microphone connection port or channel is provided, time division methodology is used to allow both audio data signals and control data signals to be transmitted from the micro-processing device to the further electronic device and/or transmitted from the further electronic device to the micro-processing device respectively.

5. A system according to claim 3 wherein the audio connection port includes the at least one microphone input connection means and/or the audio connection port is integral with the microphone input connection means.

6. A system according to claim 3 wherein if two or more audio output means or channels are provided for a stereo audio output, one of the audio output means or channels can be used to send one or more data or control signals to the further electronic device, the at least other audio output means or channels can be used to send one or more audio data signals to the further electronic device.

7. A system according to claim 3 wherein the micro-processing device includes a jack having at least three channels; two audio channels and one microphone channel, with one audio channel capable of sending one or more audio data signals to the further electronic device, the other audio channel capable of sending one or more control data signals to the further electronic device and the microphone channel used to receive one or more audio and control data signals from the further electronic device to the micro-processing device; or the micro-processing device includes four channels; two audio channels and two microphone channels, with one or more audio data signals sent via one audio channel from the micro-processing device to the further electronic device, one or more control data signals sent via the other audio channel from the micro-processing device to the further electronic device, one or more audio data signals sent via one microphone channel from the further electronic device to the micro-processing device, and one or more control data signals sent via the other microphone channel from the further electronic device to the micro-processing device.

8. A system according to claim 1 wherein the further electronic device is connected to the micro-processing device via any or any combination of one or more cables, wires, headphone cables or audio cables.

9. A system according to claim 1 wherein the micro-processing device is any of a smart phone, mobile phone, personal digital assistant (PDA), palm computer, MP3 player, Android phone or I-phone and/or includes any or any combination of internet connection means, WiFi, gyro-sensing means, acceleration measuring means, wireless communication means, navigation means, camera means, video means or mobile telephone communication means.

10. A system according to claim 1 wherein the further electronic device includes one or more input/output (IO) means for allowing micro-processing means of said further electronic device to control one or more electrical or electronic peripheral devices.

11. A system according to claim 10 wherein the one or more electrical or electronic peripheral devices include any or any combination of drive means, illumination means, sensing means, actuating means, speaker means, one or more motors, light emitting diodes (LEDs), microphones, touch sensors or actuation buttons.

12. A system according to claim 1 wherein the further electronic device is in the form of a toy, robot or doll.

13. A system according to claim 1 wherein two or more micro-processing devices are provided and at least one further electronic device, and wherein at least one of the two or more micro-processing devices is associated with, forms part of or is provided in the at least one further electronic device.

14. A system according to claim 13 wherein the at least one further electronic device includes location means or any or any combination of one or more recesses, apertures, cavities, clips or attachment means for allowing location of one of the micro-processing means therewith in use.

15. A method of using a micro-processing device control system, said system comprising:
a micro-processing device, and a further electronic device connectable to or capable of communication with said micro-processing device, said micro-processing device including audio connection means and microphone connection means, and wherein said method includes the steps of using said audio connection means to transmit one or more audio data signals and control data signals to said further electronic device to allow said micro-processing device to control one or more functions of said further electronic device, and using said microphone connection means to receive one or more audio data signals and control data signals from said further electronic device for allowing control and/or feedback from said further electronic device to said micro-processing device.
